(19) United States
(12) Patent Application Publication
(10) Pub. No.: US 2026/0255364 A1
(43) Pub. Date: Aug. 27, 2026

(54) DYNAMIC ANTENNA ADAPTATION

(71) Applicant: QUALCOMM Incorporated, San Diego, CA (US)

(72) Inventors: Diana MAAMARI, San Diego, CA (US); Gabi SARKIS, San Diego, CA (US); Harish VENKATACHARI, San Jose, CA (US); Sibasish DAS, San Diego, CA (US); Hobin KIM, San Diego, CA (US)

(21) Appl. No.: 19/062,005

(22) Filed: Feb. 24, 2025

(51) Int. Cl. H04W 72/232; H04W 72/0446

(52) U.S. Cl. CPC H04W 72/232; H04W 72/0446

(57) ABSTRACT

Certain aspects of the present disclosure provide techniques for wireless communications. An example method includes receiving first downlink control information (DCI) indicating a first quantity of antennas for downlink communication reception, wherein the first quantity of antennas is associated with a first application timeline; receiving, after receiving the first DCI and within the first application timeline, second DCI indicating a second quantity of antennas for downlink communication reception, wherein the second quantity of antennas is associated with a second application timeline; and receiving a downlink communication using the first quantity of antennas or using the second quantity of antennas based at least in part on timing of the downlink communication relative to at least one of the first application timeline or the second application timeline.

### FIELD OF THE DISCLOSURE

Aspects of the present disclosure relate to wireless communications, and more particularly, to techniques for dynamic antenna adaptation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communication by a user equipment (UE). The method includes receiving first downlink control information (DCI) indicating a first quantity of antennas for downlink communication reception, wherein the first quantity of antennas is associated with a first application timeline; receiving, after receiving the first DCI and within the first application timeline, second DCI indicating a second quantity of antennas for downlink communication reception, wherein the second quantity of antennas is associated with a second application timeline; and receiving a downlink communication using the first quantity of antennas or using the second quantity of antennas based at least in part on timing of the downlink communication relative to at least one of the first application timeline or the second application timeline.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for communications in a network between a UE and a network entity.

FIGS. 6-9 depict examples associated with dynamic antenna adaptation in the context of the process flow depicted and described with respect to FIG. 5.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for dynamic antenna adaptation.

Reducing power consumption of UE is an important consideration with respect to operation of a UE in a wireless communication system. Techniques for reducing UE power consumption can include, for example, a time-based adaptation technique (e.g., search space set group (SSSG) switching), a frequency-based adaptation technique (e.g., bandwidth adaptation), or an antenna-based adaptation technique, such as adaptive receive diversity (ARD). An antenna-adaptation technique, such as ARD, may enable a UE to power off one or more antennas at a given time. Active antennas of the UE consume battery power in association with, for example, radio frequency (RF) processing, baseband processing, RF front-end operation, or the like. Therefore, by enabling one or more antennas to be (selectively) powered off, an antenna adaptation technique such as ARD can serve to reduce UE power consumption.

In some wireless communication systems, bandwidth part (BWP) switching can enable one or more adaptation techniques (e.g., a time-based adaptation technique, a frequency-based adaptation techniques, or an antenna-based adaptation technique) at a UE. For example, different BWPs may be configured with different configurations for adaptation techniques, and switching between the different BWPs can enable transitions between the different configurations. However, BWP switching suffers in a scenario in which a UE and a network entity (e.g., a base station) are out-of-sync with respect to an active BWP, such as due to the UE missing an instruction to switch BWPs or the network entity missing an acknowledgment of such an instruction. For example, the UE and the network entity being out-of-sync with respect to the active BWP can result in an undesirably long switching time in association with performing an adaptation, which increases latency with respect to communication between the UE and the network entity and, therefore, degrades performance.

In some wireless communication systems, dynamic antenna adaptation may be implemented in association with providing antenna adaptation (e.g., ARD). In general, dynamic antenna adaptation can be used to dynamically control a quantity of active antennas of a UE at a given time. In some cases, dynamic adaptation can use downlink control information (DCI) indications that (e.g., explicitly) indicate a quantity of antennas that the UE is to use for reception of a downlink communication (e.g., a physical downlink control channel (PDCCH) communication, a physical downlink shared channel communication (PDSCH) communication, or the like). Therefore, in practice, the DCI indication may cause the UE to activate (or deactivate) one or more antennas in response to the DCI indication. In some systems, dynamic antenna adaptation may be included in a so-called “Light” adaptation framework in which DCI sizes do not change. In practice, a UE switch from a first quantity of antennas (e.g., two antennas) to a second quantity of antennas (e.g., four antennas) requires some amount of time. That is, a change from using a first quantity of antennas to using a second quantity of antennas requires some amount of time for the change to be applied at the UE. This amount of time is herein referred to as an application timeline. Of note, a UE may be capable of receiving some communications (e.g., PDCCH transmissions) during an application timeline associated with an antenna switch.

A technical problem can arise with respect to dynamic antenna adaption when a UE receives multiple DCI indications over a relatively short period of time. As a specific example, a UE may receive, in a first slot, a first DCI indicating that the UE is to use a first quantity of antennas (e.g., two antennas) for downlink communication reception. The UE may begin a switching process for operating using the first quantity of antennas based on the first DCI. Here, the switching process for operating use the first quantity of antennas has a first application timeline. In this example, the UE receives, in a second slot (e.g., a slot immediately following the first slot) and within the first application timeline, a second DCI indicating that the UE is to use a second quantity of antennas (e.g., four antennas) for downlink communication reception. In this scenario, a behavior of the UE is not defined, meaning whether the UE should operate according the first DCI or according to the second DCI, or should switch to operating based on the first DCI to operating based on the second DCI, is not configured. As a result, dynamic antenna adaption may not be applied as intended, meaning that the UE power savings that could otherwise be realized through dynamic adaption are not achieved.

Aspects described herein may overcome the aforementioned technical problem, for example, by providing a UE behavior for a scenario in which the UE receives conflicting indications associated with performing dynamic antenna adaptation. In some aspects, the UE may receive first DCI indicating a first quantity of antennas for downlink communication reception. The UE may then receive, within an application timeline associated with the first quantity of antennas (or first DCI), a second DCI indicating a second quantity of antennas for downlink communication reception. The UE may then receive a downlink communication using the first quantity of antennas or using the second quantity of antennas. In some aspects, whether the UE receives the downlink communication using the first quantity of antennas or the second quantity of antennas is based at least in part on timing of the downlink communication (e.g., relative to the first application timeline). That is, the UE may in some aspects resolve the conflicting dynamic antenna adaptation indications based at least in part on a timing of the downlink communication.

Certain techniques for dynamic antenna adaptation described herein may provide various beneficial technical effects and/or advantages. For example, the techniques for dynamic antenna adaptation may enable improved wireless communications performance, such as reduced power consumption. The reduced power consumption may be attributable to the techniques and apparatuses for dynamic antenna adaptation described herein, for example, due to behavior of the UE being defined in a scenario in which the UE receives conflicting indications associated with dynamic antenna adaptation. Here the UE behavior being defined can enable dynamic antenna adaption to be reliably and consistently applied, thereby achieving UE power savings through dynamic adaption. Furthermore, the techniques described herein provide dynamic antenna adaptation without BWP switching, thereby reducing the likelihood of out-of-sync BWP switching.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

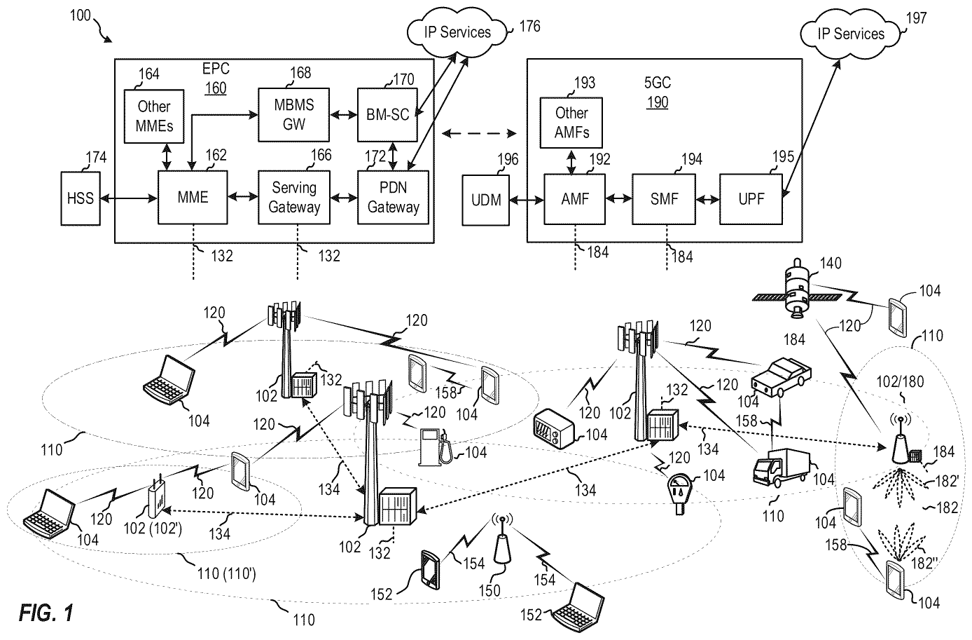

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

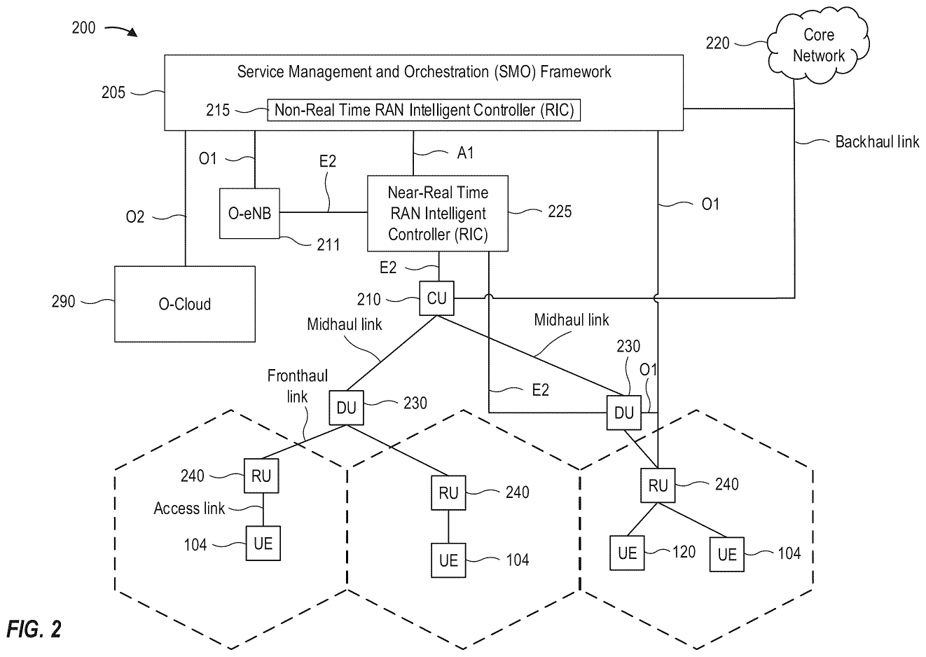

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

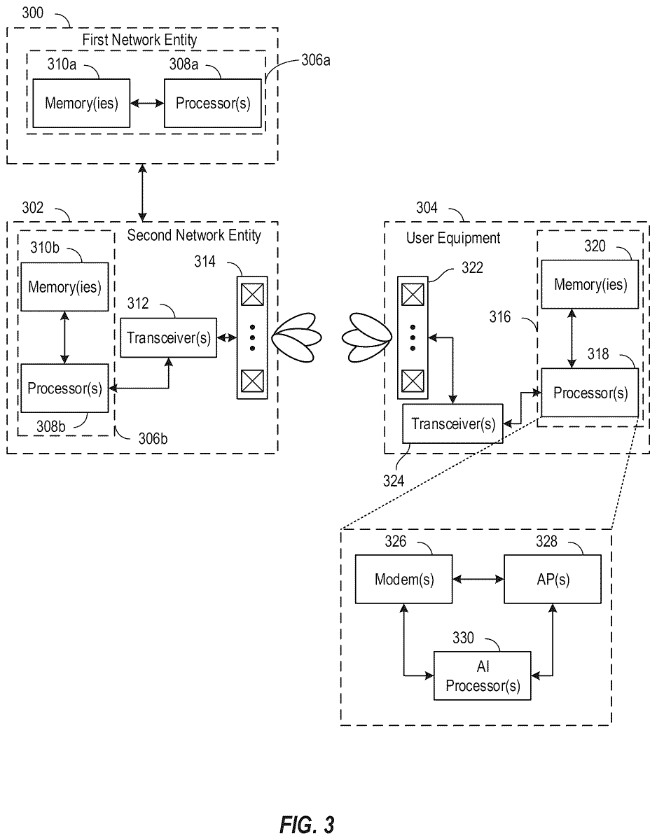

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

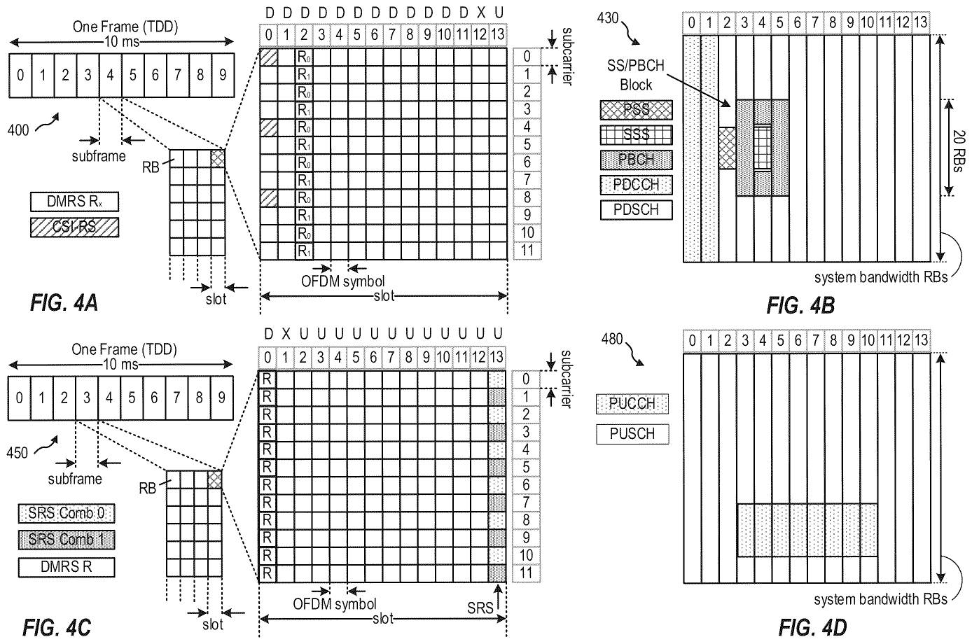

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Signaling of Dynamic Antenna Adaptation

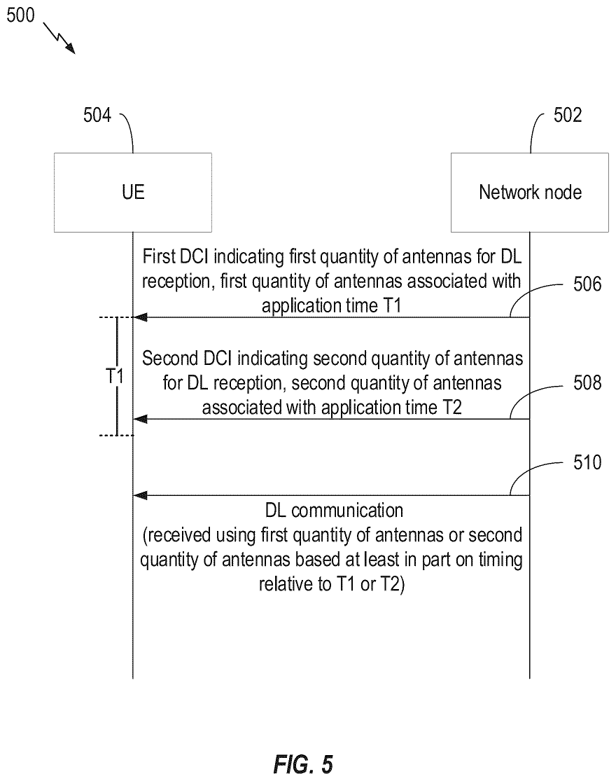

FIG. 5 depicts a process flow 500 for communications in a network between a network entity 502 and a UE 504. In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1 or the UE 304 depicted and described with respect to FIG. 3. However, in other aspects, UE 504 may be another type of wireless communications device and network entity 502 may be another type of network entity or network node, such as those described herein. Note that any operations or signaling illustrated with dashed lines may indicate that that operation or signaling is an optional or alternative example.

At 506, the UE 504 receives, from the network entity 502, a first DCI indicating a first quantity of antennas for downlink communication reception. For example, the UE 504 may receive, in a first slot, a first PDCCH that includes first DCI. The first DCI may include a field (e.g., a PDCCH antenna adaptation field) carrying a first value that indicates a first quantity of antennas (e.g., two antennas, four antennas, or the like) for downlink communication (e.g., PDCCH, PDSCH, or the like) reception.

In some aspects, the first quantity of antennas is associated with a first application timeline. The first quantity of antennas may be associated with the first application timeline in that the first application timeline is specific to the first quantity of antennas, or in that the first application timeline is measured from when the first PDCCH is received. As used herein, an application timeline is an amount of time for the UE 504 to apply a change indicated by DCI indicating a quantity of antennas for downlink communication reception. For example, for a DCI indicating two antennas for downlink communication reception, an application timeline is an amount of time for the UE 504 to perform operations such that the UE 504 is able to receive downlink communications using two antennas. As another example, for a DCI indicating four antennas for downlink communication reception, an application timeline is an amount of time for the UE 504 to perform operations such that the UE 504 is able to receive downlink communications using four antennas. The one or more operations to be performed during an application timeline may include operations associated with activating one or more antennas or deactivating one or more antennas, such as powering-on or powering-off one or more RF components, tuning or modifying one or more RF components, or activating or deactivating one or more RF chains, among other examples. In some aspects, an application timeline can be in units of slots, symbols, or another unit in the time domain.

In some aspects, an application timeline associated with activating one or more antennas maybe different from an application timeline associated with deactivating one or more antennas. For example, an application timeline associated with deactivating antennas so as to enable the UE 504 to use four antennas for downlink communication reception may be different from an application associated with activating antennas so as to enable the UE 504 to use four antennas for downlink communication reception. In some aspects, an application timeline associated with deactivating antennas may be comparatively shorter (e.g., at the symbol level), while an application timeline associated with activating antennas may be comparatively longer (e.g., at a slot level). Therefore, a first application timeline, as used herein, may in some aspects be a first time duration associated with antenna activation, while a second application timeline may be a second time duration associated with antenna deactivation, with the first time duration being different from the second time duration. Similarly, in some aspects, the first application timeline may be a first time duration associated with antenna deactivation and the second application timeline may be a second time duration associated with antenna activation, with the first time duration is different from the second time duration. In some aspects, one or more application timelines associated with one or more quantities of antennas may be based at least in part on a UE capability. In the process flow 500, the first quantity of antennas is associated with a first application timeline T1, which is illustrated in FIG. 5.

In some aspects, the UE 504 may transmit, to the network entity 502, UE capability information that indicates one or more application timelines associated with respective quantities of antennas of the UE 504. For example, in the context of the process flow 500, the UE 504 may transmit, to the network entity 502, an uplink communication that indicates the first application timeline T1 associated with the first quantity of antennas and that indicates a second application timeline T2 associated with a second quantity of antennas (as described below with respect to reference 508). In some aspects, the UE 504 may provide the UE capability information in UE assistance information (UAI), uplink control information (UCI), a medium access control (MAC) control element (CE), or the like. In some aspects, the UE 504 may transmit the capability information prior to receiving the first DCI at 506.

At 508, the UE 504 receives, from the network entity 502, second DCI indicating a second quantity of antennas for downlink communication reception. For example, the UE 504 may receive, in a second slot, a second PDCCH that includes second DCI. The second DCI may include a field carrying a second value that indicates a second quantity of antennas (e.g., four antennas, two antennas, or the like) for downlink communication reception. In some aspects, the second quantity of antennas is associated with a second application timeline. For example, in the process flow 500, the second quantity of antennas is associated with a second application timeline T2. The second quantity of antennas may be associated with the second application timeline in that the second application timeline is specific to the second quantity of antennas, or in that the second application timeline is measured from when the second PDCCH is received.

In some aspects, as shown in the process flow 500, the UE 504 receives the second DCI after receiving the first DCI and within the first application timeline. For example, in the context of the process flow 500, the UE 504 receives the second DCI after receiving the first DCI, with the second DCI being received within the first application timeline T1 (e.g., within T1 slots or symbols from the slot in which the first DCI was received).

At 510, the UE 504 receives the downlink communication from the network entity 502. In some aspects, the quantity of antennas used by the UE 504 to receive the downlink communication is based at least in part on timing of the downlink communication relative to at least one of the first application timeline T1 or the second application timeline T2. Thus, in some aspects, the UE 504 receives the downlink communication using the first quantity of antennas. Alternatively, the UE 504 may in some aspects receive the downlink communication using the second quantity of antennas.

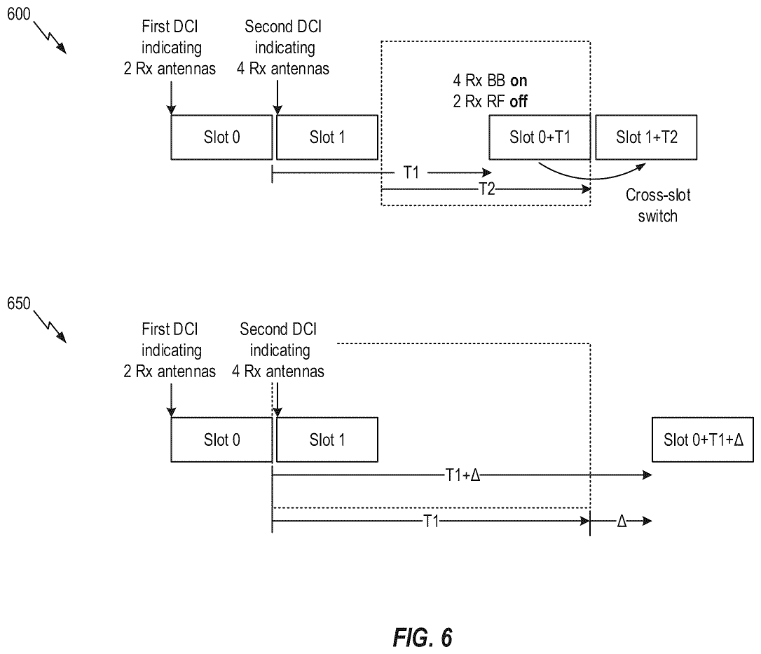

In some aspects, the UE 504 may receive the downlink communication using the second quantity of antennas based at least in part on the first quantity of antennas being less than the second quantity of antennas and the downlink communication at 510 being in a resource that is after the second application timeline T2. For example, with reference to example 600 shown in FIG. 6, the UE 504 may receive, in slot 0, first DCI indicating two antennas for downlink communication reception. Here, the switch to two antennas is associated with a first application timeline T1. As further shown, the UE 504 may receive, in slot 1, second DCI indicating four antennas for downlink communication reception. Here, the switch to four antennas is associated with a second application T2. In some examples, if the downlink communication is to be received in a resource that is after the second application timeline T2 (e.g., in slot 1+T2 or in other words at least T2 slots after slot 1), then the UE 504 may receive the downlink communication using four antennas. In some other examples, as illustrated in the example 600, if the downlink communication is to be received in a resource that within the second application timeline T2 (e.g., in slot 0+T1 or in other words less than T2 slots after slot 1), then the UE 504 may receive the downlink communication using two antennas. Of note, in the example 600, the second quantity of antennas (e.g., four antennas) is used for downlink communication reception after the application timeline T2, while the first quantity of antennas (e.g., two antennas) is used for downlink communication reception before the application timeline T2. Notably, such aspects may be utilized when a receive baseband configuration associated with using the second quantity of antennas remains powered-on and/or configured for four-antenna reception at the UE 504 (e.g., “4 Rx BB on” as indicated in the example 600) within the second application timeline T2, even though RF components associated with one or more antennas (e.g., “2 Rx RF off” as indicated in the example 600) are powered off (e.g., such that RF paths on two receive chains are powered off, while the rest of a modem consumes power). As indicated in the example 600, such a configuration enables cross-slot switching to a higher power state (e.g., such that the UE 504 can switch from the use of two antennas to the use of four antennas between slot 0+T1 and slot 1+T2). Thus, when a UE receives a first PDCCH in a first slot that provides a DCI with PDCCH antenna adaptation field having a first value indicating a change in the number of antennas for PDCCH/PDSCH and a second PDCCH that provides a DCI format with a PDCCH antenna adaptation having a second value indicating a change in the number of antennas for PDCCH/PDSCH before a slot that is at least T symbols/slots after the first slot, the number of antennas indicated in the second PDCCH applies after at least the T symbols/slots from the second PDCCH. Before then the UE can receive grants with the number of antennas indicated in the first PDCCH only.

In some aspects, the UE 504 may receive the downlink communication using the second quantity of antennas based at least in part on the first quantity of antennas being less than the second quantity of antennas and the downlink communication being in a resource that is after a time defined by the first application timeline plus a time offset. For example, with reference to example 650 in FIG. 6, the UE 504 may receive, in slot 0, first DCI indicating two antennas for downlink communication reception. Here, the switch to two antennas is associated with a first application timeline T1. As further shown, the UE 504 may receive, in slot 1, second DCI indicating four antennas for downlink communication reception. In some examples, if the downlink communication is to be received in a resource that is after a time defined by the first application timeline T1 plus a time offset Δ (e.g., in slot 0+T1+Δ or in other words at least T1+Δ slots after slot 0), then the UE 504 may receive the downlink communication using four antennas. In another example, as illustrated in the example 650, if the downlink communication is to be received in a resource that is within the time defined by the first application timeline T1 plus the time offset Δ, then the UE 504 may receive the downlink communication using two antennas. Of note, in the example 650, the second quantity of antennas is used for downlink communication reception after the time period corresponding to T1+Δ, while the first quantity of antennas (e.g., two antennas) is used for downlink communication reception prior to the time period corresponding to T1+Δ. The time offset Δ may provide for antenna switching that conforms to a UE's capabilities. Thus, when a UE receives a first PDCCH in a first slot that provides a DCI with PDCCH antenna adaptation field having a first value indicating a change in the number of antennas for PDCCH/PDSCH and a second PDCCH that provides a DCI format with a PDCCH antenna adaptation having a second value indicating a change in the number of antennas for PDCCH/PDSCH before a slot that is at least T symbols/slots after the first slot, the second PDCCH applies after T+Δ symbols/slots from the first PDCCH.

In some aspects, the UE 504 may transmit, to the network entity 502, UE capability information that indicates the time offset Δ. In some aspects, the UE 504 may provide the UE capability information in UAI, UCI, a MAC CE, or the like.

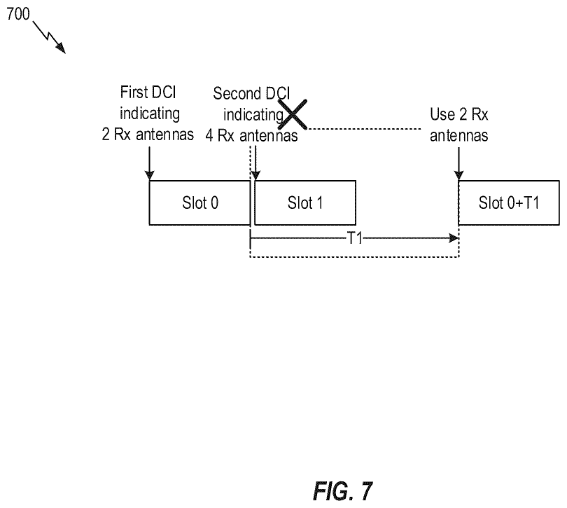

In some aspects, the UE 504 may receive the downlink communication using the first quantity of antennas based at least in part on a configuration indicating that the second quantity of antennas cannot be different from the first quantity of antennas. For example, with reference to example 700 in FIG. 7, the UE 504 may receive, in slot 0, first DCI indicating two antennas for downlink communication reception. Here, the switch to two antennas is associated with a first application timeline T1. As further shown, the UE 504 may receive, in slot 1, second DCI indicating four antennas for downlink communication reception. In this example, the UE 504 has a configuration indicating that the second quantity of antennas cannot be different from the first quantity of antennas. That is, the UE 504 is configured so as not to expect the second quantity of antennas to be different from the first quantity of antennas. Therefore, as indicated in the example 700, the UE 504 disregards the indication of the second quantity of antennas and receives the downlink communication (e.g., in slot 0+T1) using the first quantity of antennas. Thus, when a UE receives a first PDCCH in a first slot that provides a DCI with PDCCH antenna adaptation field having a first value indicating a change in the number of antennas for PDCCH/PDSCH and a second PDCCH that provides a DCI format with a PDCCH antenna adaptation having a second value indicating a change in the number of antennas for PDCCH/PDSCH before a slot that is at least T symbols/slots after the first slot if the first value indicates antenna adaptation, then the UE does not expect the second value to be different than the first value.

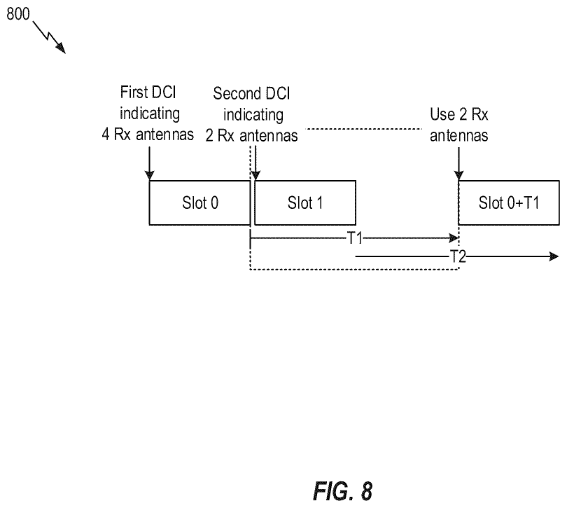

In some aspects, the UE 504 may receive the downlink communication using the second quantity of antennas based at least in part on the downlink communication being in a resource that is after the first application timeline. For example, with reference to example 800 in FIG. 8, the UE 504 may receive, in slot 0, first DCI indicating four antennas for downlink communication reception. Here, the switch to four antennas is associated with a first application timeline T1. As further shown, the UE 504 may receive, in slot 1, second DCI indicating two antennas for downlink communication reception. Here, the switch to two antennas is associated with a second application timeline T2. In some examples, if the downlink communication is to be received in a resource that is after the first application timeline T1 (e.g., in slot 0+T1—at least T1 slots after slot 0), then the UE 504 may receive the downlink communication using two antennas. Of note, in such an aspect, the quantity of antennas indicated in the second DCI is used after the first application timeline T1 (e.g., even if the downlink communication is in a resource that is before an end of the second application timeline T2). Thus, when a UE receives a first PDCCH in a first slot that provides a DCI with PDCCH antenna adaptation field having a first value indicating a change in the number of antennas for PDCCH/PDSCH and a second PDCCH that provides a DCI format with a PDCCH antenna adaptation having a second value indicating a change in the number of antennas for PDCCH/PDSCH before a slot that is at least T symbols/slots after the first slot, then the second PDCCH applies after at least T symbols/slots from the first PDCCH.

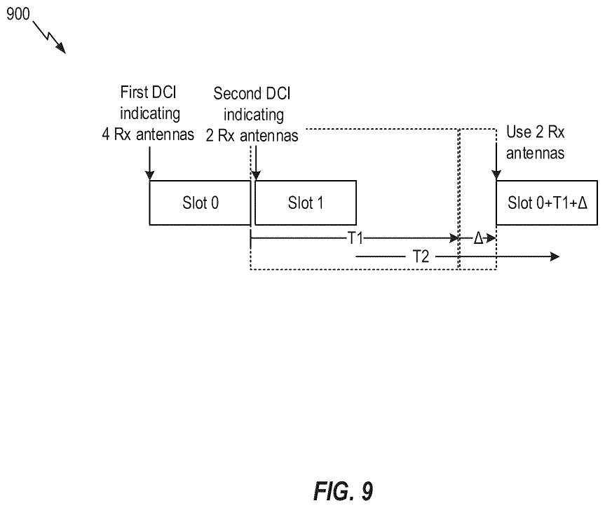

In some aspects, the UE 504 may receive the downlink communication using the second quantity of antennas based at least in part on the downlink communication being in a resource that is after a time defined by the first application timeline plus a time offset. For example, with reference to example 900 in FIG. 9, the UE 504 may receive, in slot 0, first DCI indicating four antennas for downlink communication reception. Here, the switch to four antennas is associated with a first application timeline T1. As further shown, the UE 504 may receive, in slot 1, second DCI indicating two antennas for downlink communication reception. Here, the switch to two antennas is associated with a second application timeline T2. In some examples, if the downlink communication is to be received in a resource that is after a time period defined by the first application timeline T1 plus the time offset Δ (e.g., in slot 0+T1+Δ—at least T1+Δ slots after slot 0), then the UE 504 may receive the downlink communication using two antennas. Of note, in such aspects, the quantity of antennas indicated in the second DCI is used after the first application timeline T1 plus the time offset Δ (e.g., even if the downlink communication is in a resource that is before an end of the second application timeline T2). Thus, when a UE receives a first PDCCH in a first slot that provides a DCI with PDCCH antenna adaptation field having a first value indicating a change in the number of antennas for PDCCH/PDSCH and a second PDCCH that provides a DCI format with a PDCCH antenna adaptation having a second value indicating a change in the number of antennas for PDCCH/PDSCH before a slot that is at least T+Δ symbols/slots after the first slot if the first value indicates antennas adaptation, then the second PDCCH applies after at least T+Δ symbols/slots from the first PDCCH.

In some aspects, the techniques and apparatuses for dynamic antenna adaptation described herein may be applicable to other types of adaptation. For example, the techniques and apparatuses described herein may in some aspects be used in association with adaptation of a minimum k0 parameter. The minimum k0 parameter is a parameter indicating a minimum offset (e.g., a quantity of slots) between a slot in which a PDCCH carrying DCI is communicated and a slot in which a PDSCH transmission, scheduled by the DCI, is to be communicated. Notably, a change to the minimum k0 parameter is associated with (e.g., constrained by) an application time (e.g., to adjust a baseband clock or voltage). For example, in some aspects, a UE 504 may receive first DCI indicating a first minimum k0 parameter, wherein the first minimum k0 parameter is associated with a first application timeline. The UE 504 may receive, after receiving the first DCI and within the first application timeline, second DCI indicating a second minimum k0 parameter, wherein the second minimum k0 parameter is associated with a second application timeline. In some aspects, the UE 504 may receive a downlink communication based at least in part on the first minimum k0 parameter or based at least in part on the second minimum k0 parameter based at least in part on timing of the downlink communication relative to at least one of the first application timeline or the second application timeline. In some aspects, a manner in which the UE 504 receives the downlink communication based at least in part on the first minimum k0 parameter or the second minimum k0 parameter may be similar to any of those described above with respect to the antenna adaptation of FIGS. 5-9.

For example, the UE 504 may receive a first indication (e.g., first DCI) indicating a first minimum k0 parameter (e.g., k0=0) associated with associated with first application timeline T1. The UE 504 may then receive, during the first application timeline T1, a second indication (e.g., second DCI) indicating a second minimum k0 parameter (e.g., k0>0). In some such aspects, the UE 504 may be scheduled for downlink communication reception according to the second minimum k0 parameter (e.g., k0>0) after the first application timeline T1 from the first indication, and may receive the downlink communication accordingly.

As another example, the UE 504 may receive a first indication (e.g., first DCI) indicating a first minimum k0 parameter (e.g., k0>0) associated with associated with first application timeline T1. The UE 504 may then receive, during the first application timeline T1, a second indication (e.g., second DCI) indicating a second minimum k0 parameter (e.g., k0=0) associated with a second application timeline T2. In some such aspects, the UE 504 may be scheduled for downlink communication reception according to the second minimum k0 parameter (e.g., k0=0) after the second application timeline T2 from the second indication or after the first application timeline T1 after the first application (e.g., depending on a UE capability), and may receive the downlink communication accordingly.

As another example, the UE 504 may be configured so as not to expect a second minimum k0 parameter, indicated during a first application timeline T1 associated with a first minimum k0 parameter, to be different from the first minimum k0 parameter. As a particular example, the UE 504 may receive a first indication (e.g., first DCI) indicating a first minimum k0 parameter (e.g., k0>0) associated with associated with first application timeline T1. The UE 504 may then receive, during the first application timeline T1, a second indication (e.g., second DCI) indicating a second minimum k0 parameter (e.g., k0=0). In this example, the UE 504 has a configuration indicating that the second minimum k0 parameter cannot be different from the first minimum k0 parameter. Therefore, the UE 504 may disregard the indication of the second minimum k0 parameter and be scheduled for and receive a downlink communication based at least in part on the first minimum k0 parameter.

Note that the process flow illustrated in FIG. 5 is an example of dynamic antenna adaptation, and aspects of the present disclosure may be applied to dynamic antenna adaptation. Note that the process flow illustrated in FIG. 5 is described herein to facilitate an understanding of dynamic antenna adaptation, and aspects of the present disclosure may be performed in various manners via alternative or additional signaling and/or operations. In certain aspects, the operations and/or signaling of FIG. 5 may occur in an order different from that described or depicted, and various actions, operations, and/or signaling may be added, omitted, or combined.

### Example Operations of a User Equipment

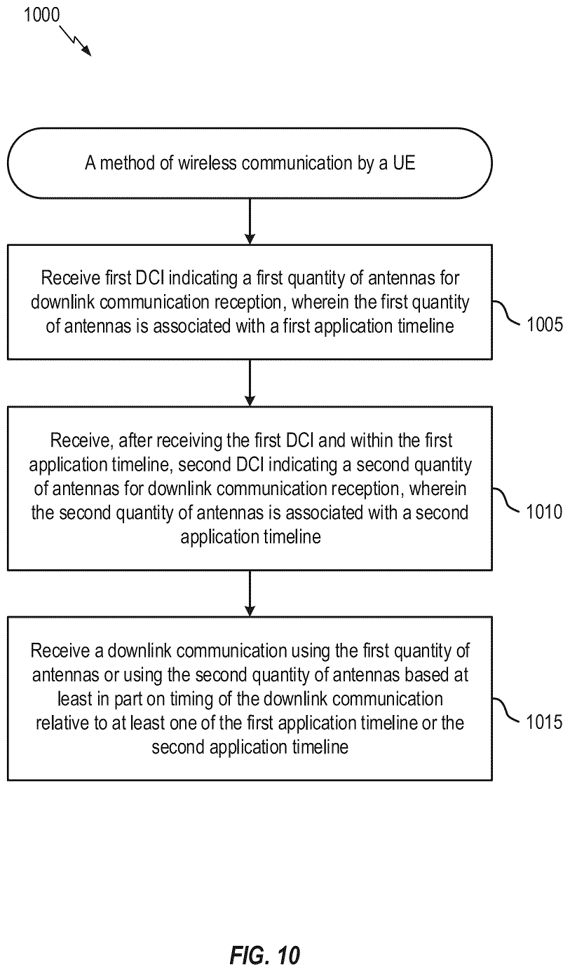

FIG. 10 shows a method 1000 for wireless communication by a UE, such as UE 104 of FIG. 1 or UE 304 of FIG. 3.

Method 1000 begins at block 1005 with receiving first DCI indicating a first quantity of antennas for downlink communication reception, wherein the first quantity of antennas is associated with a first application timeline. For example, a UE 504 may receive first DCI indicating a first quantity of antennas for downlink communication reception, wherein the first quantity of antennas is associated with a first application timeline, as described above with respect to reference 506 of the process flow 500.

Method 1000 then proceeds to block 1010 with receiving, after receiving the first DCI and within the first application timeline, second DCI indicating a second quantity of antennas for downlink communication reception, wherein the second quantity of antennas is associated with a second application timeline. For example, the UE 504 may receive second DCI indicating a second quantity of antennas for downlink communication reception, wherein the second quantity of antennas is associated with a second application timeline, as described above with respect to reference 508 of the process flow 500.

Method 1000 then proceeds to block 1015 with receiving a downlink communication using the first quantity of antennas or using the second quantity of antennas based at least in part on timing of the downlink communication relative to at least one of the first application timeline or the second application timeline. For example, the UE 504 may perform a downlink communication using the first quantity of antennas or using the second quantity of antennas based at least in part on timing of the downlink communication relative to at least one of the first application timeline or the second application timeline, as described above with respect to reference 510 of the process flow 500. In some aspects, the UE may deactivate or activate one or more antennas to implement the second quantity of antennas in order to receive the downlink communication. In some aspects, the UE may continue to power one or more antennas to implement the first quantity of antennas in order to receive the downlink communication.

In some aspects, the method 1000 may overcome the technical problem of realizing UE power savings in a dynamic antenna adaptation scheme by, for example, providing a behavior of a UE for a scenario in which the UE receives conflicting indications associated with performing dynamic antenna adaptation. The realized reduced power consumption may be attributable to the method 1000 due to, for example, the behavior of the UE being based at least in part on timing of a downlink communication to be received by the UE with respect to one or more of the indications associated with performing dynamic antenna adaptation. In this way, the method 1000 may enable dynamic antenna adaption to be reliably and consistently applied, thereby realizing UE power savings, even in the case of conflicting indications.

In some aspects, block 1015 includes receiving the downlink communication using the second quantity of antennas based at least in part on the first quantity of antennas being less than the second quantity of antennas and the downlink communication being in a resource that is after the second application timeline.

In some aspects, block 1015 includes receiving the downlink communication using the first quantity of antennas based at least in part on the first quantity of antennas being less than the second quantity of antennas and the downlink communication being in a resource that is within the second application timeline.

In some aspects, block 1015 includes receiving the downlink communication using the second quantity of antennas based at least in part on the first quantity of antennas being less than the second quantity of antennas and the downlink communication being in a resource that is after a time defined by the first application timeline plus a time offset.

In some aspects, block 1015 includes receiving the downlink communication using the first quantity of antennas based at least in part on the first quantity of antennas being less than the second quantity of antennas and the downlink communication being in a resource that is within a time defined by the first application timeline plus a time offset.

In some aspects, method 1000 further includes transmitting UE capability information indicating at least one of the first application timeline, the second application timeline, or a time offset.

In some aspects, block 1015 includes receiving the downlink communication using the first quantity of antennas based at least in part on a configuration indicating that the second quantity of antennas cannot be different from the first quantity of antennas.

In some aspects, block 1015 includes receiving the downlink communication using the second quantity of antennas based at least in part on the downlink communication being in a resource that is after the first application timeline.

In some aspects, block 1015 includes receiving the downlink communication using the second quantity of antennas based at least in part on the downlink communication being in a resource that is after a time defined by the first application timeline plus a time offset.

In some aspects, the first application timeline is a first time duration associated with antenna activation and the second application timeline is a second time duration associated with antenna deactivation, wherein the first time duration is different from the second time duration.

In some aspects, the first application timeline is a first time duration associated with antenna deactivation and the second application timeline is a second time duration associated with antenna activation, wherein the first time duration is different from the second time duration.

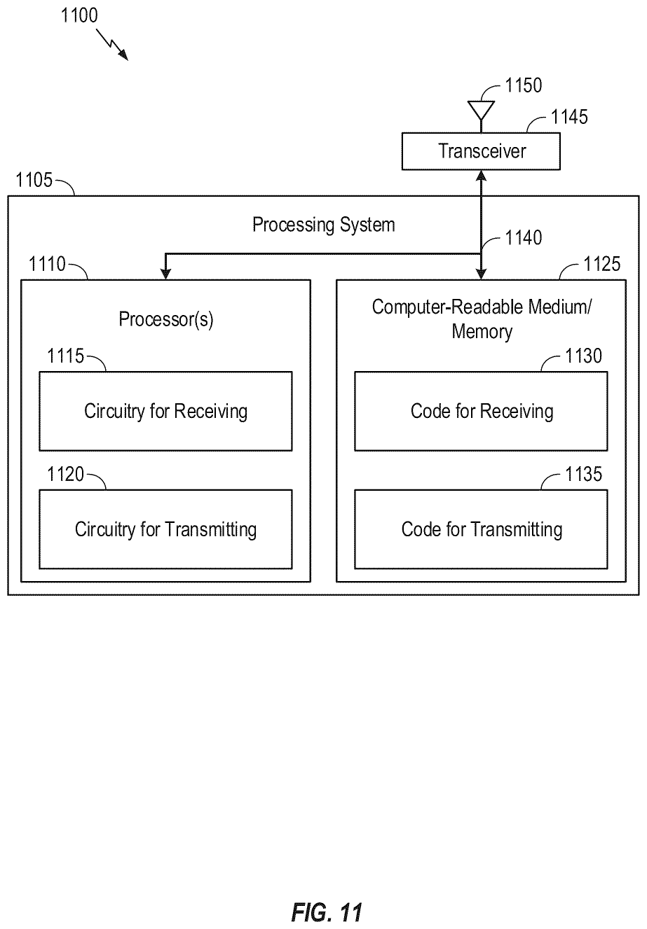

In some aspects, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative operations are possible consistent with this disclosure.

### Example Communications Device

FIG. 11 depicts aspects of an example communications device 1100 configured for wireless communications. In some aspects, communications device 1100 is a user equipment, such as UE 104 described above with respect to FIG. 1 or UE 304 described with respect to FIG. 3.

The communications device 1100 includes a processing system 1105 coupled to a transceiver 1145 (e.g., a transmitter and/or a receiver). The transceiver 1145 is configured to transmit and receive signals for the communications device 1100 via an antenna 1150, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1125. In various aspects, the one or more processors 1110 may be representative of the one or more processors 318 described with respect to FIG. 3. The one or more processors 1110 are coupled to a computer-readable medium/memory 1125 via a bus 1140. In some aspects, the computer-readable medium/memory 1125 may be representative of the one or more memories 320 described with respect to FIG. 3. The computer-readable medium/memory 1125 is a non-transitory computer-readable medium/memory. In certain aspects, the computer-readable medium/memory 1125 is configured to store instructions (e.g., computer-executable code), that when executed by the one or more processors 1110, cause the one or more processors 1110 to perform the method 1000 described with respect to FIG. 10, or any aspect related to it, including any operations described in relation to FIG. 10. Note that reference to a processor performing a function of communications device 1100 may include one or more processors performing that function of communications device 1100, such as in a distributed fashion.

In the depicted example, computer-readable medium/memory 1125 stores code (e.g., executable instructions), including code for receiving 1130 and code for transmitting 1135. Processing of the code 1130 and 1135 may enable and cause the communications device 1100 to perform the method 1000 described with respect to FIG. 10, or any aspect related to it. For instance, in some aspects, code for receiving 1130 includes code for receiving first DCI indicating a first quantity of antennas for downlink communication reception, wherein the first quantity of antennas is associated with a first application timeline. In some aspects, code for receiving 1130 includes code for receiving, after receiving the first DCI and within the first application timeline, second DCI indicating a second quantity of antennas for downlink communication reception, wherein the second quantity of antennas is associated with a second application timeline. In some aspects, code for receiving 1130 includes code for receiving a downlink communication using the first quantity of antennas or using the second quantity of antennas based at least in part on timing of the downlink communication relative to at least one of the first application timeline or the second application timeline.

The one or more processors 1110 include circuitry configured to implement (e.g., execute) the code stored in the computer-readable medium/memory 1125, including circuitry for receiving 1115 and circuitry for transmitting 1120. Processing with circuitry 1115 and 1120 may enable and cause the communications device 1100 to perform the method 1000 described with respect to FIG. 10, or any aspect related to it. For instance, in some aspects, circuitry for receiving 1115 includes circuitry for receiving first DCI indicating a first quantity of antennas for downlink communication reception, wherein the first quantity of antennas is associated with a first application timeline. In some aspects, circuitry for receiving 1115 includes circuitry for receiving, after receiving the first DCI and within the first application timeline, second DCI indicating a second quantity of antennas for downlink communication reception, wherein the second quantity of antennas is associated with a second application timeline. In some aspects, circuitry for receiving 1115 includes circuitry for receiving a downlink communication using the first quantity of antennas or using the second quantity of antennas based at least in part on timing of the downlink communication relative to at least one of the first application timeline or the second application timeline.

More generally, means for communicating, transmitting, sending or outputting for transmission may include the one or more transceivers 324, one or more antenna 322 and/or processing system 316 of the UE 304 illustrated in FIG. 3, transceiver 1145 and/or antenna 1150 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1145 and/or antenna 1150 of the communications device 1100 in FIG. 11, and/or one or more processors 1110 of the communications device 1100 in FIG. 11.

### Example Clauses

Implementation examples are described in the following numbered clauses:

Clause 1: A method of wireless communication by a UE, comprising: receiving first DCI indicating a first quantity of antennas for downlink communication reception, wherein the first quantity of antennas is associated with a first application timeline; receiving, after receiving the first DCI and within the first application timeline, second DCI indicating a second quantity of antennas for downlink communication reception, wherein the second quantity of antennas is associated with a second application timeline; and receiving a downlink communication using the first quantity of antennas or using the second quantity of antennas based at least in part on timing of the downlink communication relative to at least one of the first application timeline or the second application timeline.

Clause 2: The method of Clause 1, wherein receiving the downlink communication comprises receiving the downlink communication using the second quantity of antennas based at least in part on the first quantity of antennas being less than the second quantity of antennas and the downlink communication being in a resource that is after the second application timeline.

Clause 3: The method of any one of Clauses 1-2, wherein receiving the downlink communication comprises receiving the downlink communication using the first quantity of antennas based at least in part on the first quantity of antennas being less than the second quantity of antennas and the downlink communication being in a resource that is within the second application timeline.

Clause 4: The method of any one of Clauses 1-3, wherein receiving the downlink communication comprises receiving the downlink communication using the second quantity of antennas based at least in part on the first quantity of antennas being less than the second quantity of antennas and the downlink communication being in a resource that is after a time defined by the first application timeline plus a time offset.

Clause 5: The method of any one of Clauses 1-4, wherein receiving the downlink communication comprises receiving the downlink communication using the first quantity of antennas based at least in part on the first quantity of antennas being less than the second quantity of antennas and the downlink communication being in a resource that is within a time defined by the first application timeline plus a time offset.

Clause 6: The method of any one of Clauses 1-5, further comprising transmitting UE capability information indicating at least one of the first application timeline, the second application timeline, or a time offset.

Clause 7: The method of any one of Clauses 1-6, wherein receiving the downlink communication comprises receiving the downlink communication using the first quantity of antennas based at least in part on a configuration indicating that the second quantity of antennas cannot be different from the first quantity of antennas.

Clause 8: The method of any one of Clauses 1-7, wherein receiving the downlink communication comprises receiving the downlink communication using the second quantity of antennas based at least in part on the downlink communication being in a resource that is after the first application timeline.

Clause 9: The method of any one of Clauses 1-8, wherein receiving the downlink communication comprises receiving the downlink communication using the second quantity of antennas based at least in part on the downlink communication being in a resource that is after a time defined by the first application timeline plus a time offset.

Clause 10: The method of any one of Clauses 1-9, wherein the first application timeline is a first time duration associated with antenna activation and the second application timeline is a second time duration associated with antenna deactivation, wherein the first time duration is different from the second time duration.

Clause 11: The method of any one of Clauses 1-10, wherein the first application timeline is a first time duration associated with antenna deactivation and the second application timeline is a second time duration associated with antenna activation, wherein the first time duration is different from the second time duration.

Clause 12: One or more apparatuses, comprising: one or more memories comprising executable instructions; and one or more processors configured to execute the executable instructions and cause the one or more apparatuses to perform a method in accordance with any one of Clauses 1-11.

Clause 13: One or more apparatuses configured for wireless communications, comprising: one or more memories; and one or more processors, coupled to the one or more memories, configured to cause the one or more apparatuses to perform a method in accordance with any one of Clauses 1-11.

Clause 14: One or more apparatuses configured for wireless communications, comprising: one or more memories; and one or more processors, coupled to the one or more memories, configured to perform a method in accordance with any one of Clauses 1-11.

Clause 15: One or more apparatuses, comprising means for performing a method in accordance with any one of Clauses 1-11.

Clause 16: One or more non-transitory computer-readable media comprising executable instructions that, when executed by one or more processors of one or more apparatuses, cause the one or more apparatuses to perform a method in accordance with any one of Clauses 1-11.

Clause 17: One or more computer program products embodied on one or more computer-readable storage media comprising code for performing a method in accordance with any one of Clauses 1-11.

Clause 18: One or more apparatuses configured for wireless communications, comprising: a processing system that includes one or more processors and one or more memories coupled with the one or more processors, the processing system configured to cause the one or more apparatuses to perform a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE):
receive first downlink control information (DCI) indicating a first quantity of antennas for downlink communication reception, wherein the first quantity of antennas is associated with a first application timeline;
receive, after receiving the first DCI and within the first application timeline, second DCI indicating a second quantity of antennas for downlink communication reception, wherein the second quantity of antennas is associated with a second application timeline; and
receive a downlink communication using the first quantity of antennas or using the second quantity of antennas based at least in part on timing of the downlink communication relative to at least one of the first application timeline or the second application timeline.

2. The apparatus of claim 1, wherein to cause the UE to receive the downlink communication, the processing system is configured to cause the UE to receive the downlink communication using the second quantity of antennas based at least in part on the first quantity of antennas being less than the second quantity of antennas and the downlink communication being in a resource that is after the second application timeline.

3. The apparatus of claim 1, wherein to cause the UE to receive the downlink communication, the processing system is configured to cause the UE to receive the downlink communication using the first quantity of antennas based at least in part on the first quantity of antennas being less than the second quantity of antennas and the downlink communication being in a resource that is within the second application timeline.

4. The apparatus of claim 1, wherein to cause the UE to receive the downlink communication, the processing system is configured to cause the UE to receive the downlink communication using the second quantity of antennas based at least in part on the first quantity of antennas being less than the second quantity of antennas and the downlink communication being in a resource that is after a time defined by the first application timeline plus a time offset.

5. The apparatus of claim 1, wherein to cause the UE to receive the downlink communication, the processing system is configured to cause the UE to receive the downlink communication using the first quantity of antennas based at least in part on the first quantity of antennas being less than the second quantity of antennas and the downlink communication being in a resource that is within a time defined by the first application timeline plus a time offset.

6. The apparatus of claim 1, wherein the processing system is further configured to cause the UE to:
transmit UE capability information indicating at least one of the first application timeline, the second application timeline, or a time offset.

7. The apparatus of claim 1, wherein to cause the UE to receive the downlink communication, the processing system is configured to cause the UE to receive the downlink communication using the first quantity of antennas based at least in part on a configuration indicating that the second quantity of antennas cannot be different from the first quantity of antennas.

8. The apparatus of claim 1, wherein to cause the UE to receive the downlink communication, the processing system is configured to cause the UE to receive the downlink communication using the second quantity of antennas based at least in part on the downlink communication being in a resource that is after the first application timeline.

9. The apparatus of claim 1, wherein to cause the UE to receive the downlink communication, the processing system is configured to cause the UE to receive the downlink communication using the second quantity of antennas based at least in part on the downlink communication being in a resource that is after a time defined by the first application timeline plus a time offset.

10. The apparatus of claim 1, wherein the first application timeline is a first time duration associated with antenna activation and the second application timeline is a second time duration associated with antenna deactivation, wherein the first time duration is different from the second time duration.

11. The apparatus of claim 1, wherein the first application timeline is a first time duration associated with antenna deactivation and the second application timeline is a second time duration associated with antenna activation, wherein the first time duration is different from the second time duration.

12. A method of wireless communication by a user equipment (UE), comprising:
receiving first downlink control information (DCI) indicating a first quantity of antennas for downlink communication reception, wherein the first quantity of antennas is associated with a first application timeline;
receiving, after receiving the first DCI and within the first application timeline, second DCI indicating a second quantity of antennas for downlink communication reception, wherein the second quantity of antennas is associated with a second application timeline; and
receiving a downlink communication using the first quantity of antennas or using the second quantity of antennas based at least in part on timing of the downlink communication relative to at least one of the first application timeline or the second application timeline.

13. The method of claim 12, wherein receiving the downlink communication comprises receiving the downlink communication using the second quantity of antennas based at least in part on the first quantity of antennas being less than the second quantity of antennas and the downlink communication being in a resource that is after the second application timeline.

14. The method of claim 12, wherein receiving the downlink communication comprises receiving the downlink communication using the first quantity of antennas based at least in part on the first quantity of antennas being less than the second quantity of antennas and the downlink communication being in a resource that is within the second application timeline.

15. The method of claim 12, wherein receiving the downlink communication comprises receiving the downlink communication using the second quantity of antennas based at least in part on the first quantity of antennas being less than the second quantity of antennas and the downlink communication being in a resource that is after a time defined by the first application timeline plus a time offset.

16. The method of claim 12, wherein receiving the downlink communication comprises receiving the downlink communication using the first quantity of antennas based at least in part on the first quantity of antennas being less than the second quantity of antennas and the downlink communication being in a resource that is within a time defined by the first application timeline plus a time offset.

17. The method of claim 12, further comprising transmitting UE capability information indicating at least one of the first application timeline, the second application timeline, or a time offset.

18. The method of claim 12, wherein receiving the downlink communication comprises receiving the downlink communication using the first quantity of antennas based at least in part on a configuration indicating that the second quantity of antennas cannot be different from the first quantity of antennas.

19. The method of claim 12, wherein receiving the downlink communication comprises receiving the downlink communication using the second quantity of antennas based at least in part on the downlink communication being in a resource that is after a time defined by the first application timeline plus a time offset.

20. An apparatus for wireless communication, the apparatus comprising:
means for receiving first downlink control information (DCI) indicating a first quantity of antennas for downlink communication reception, wherein the first quantity of antennas is associated with a first application timeline;
means for receiving, after receiving the first DCI and within the first application timeline, second DCI indicating a second quantity of antennas for downlink communication reception, wherein the second quantity of antennas is associated with a second application timeline; and
means for receiving a downlink communication using the first quantity of antennas or using the second quantity of antennas based at least in part on timing of the downlink communication relative to at least one of the first application timeline or the second application timeline.
